(19) United States
(12) Patent Application Publication
(10) Pub. No.: US 2016/0255521 A1
(43) Pub. Date: Sep. 1, 2016

(54) METHOD AND APPARATUS FOR TESTING A SMART DEVICE

(71) Applicant: Xiaomi Inc., Beijing (CN)

(72) Inventors: Yanlu ZHANG, Beijing (CN); Deguo MENG, Beijing (CN); Enxing HOU, Beijing (CN)

(73) Assignee: Xiaomi Inc.

(21) Appl. No.: 15/054,876

(22) Filed: Feb. 26, 2016

(30) Foreign Application Priority Data
Feb. 26, 2015 (CN) 201510088938.8

(51) Int. Cl. H04W 24/06; H04W 4/00; H04W 76/02

(52) U.S. Cl. CPC H04W 24/06; H04W 76/02; H04W 4/008

(57) ABSTRACT

A method for testing a smart device with a terminal includes: sending a test instruction to a smart device that causes the smart device to perform a network connection test according to the test instruction; receiving a result of the network connection test from the smart device; and displaying the result of the network connection test.

### CROSS-REFERENCE TO RELATED APPLICATIONS

This application is based upon and claims priority to Chinese Patent Application No. 201510088938.8, filed Feb. 26, 2015, the entire contents of which are incorporated herein by reference.

### TECHNICAL FIELD

The present disclosure generally relates to the field of communications, and more particularly, to a method and an apparatus for testing a smart device.

### BACKGROUND

With the development of Internet technologies, smart devices have entered into a rapid development stage. Smart devices refer to various electronic devices that are capable of accessing the Internet, such as a smart light, a smart socket, a smart camera, and the like. A user may control smart devices via the Internet. For example, a user may turn a smart device on and off, view information in a smart device, and the like. However, if the smart device cannot access the Internet, the user ordinarily cannot control the smart device. Additionally, the smart device cannot send failure information to a server over the Internet to inform the user about the failure.

### SUMMARY

According to a first aspect of the present disclosure, there is provided a method for testing a smart device with a terminal, comprising: sending a test instruction to a smart device that causes the smart device to perform a network connection test according to the test instruction; receiving a result of the network connection test from the smart device; and displaying the result of the network connection test.

According to a second aspect of the present disclosure, there is provided an apparatus for testing a smart device, comprising: a processor; and a memory for storing instructions executable by the processor; wherein the processor is configured to: send a test instruction to a smart device that causes the smart device to perform a network connection test according to the test instruction; receive a result of the network connection test from the smart device; and display the result of the network connection test.

According to a third aspect of the present disclosure, there is provided a non-transitory computer-readable storage medium having stored therein instructions that, when executed by one or more processors of a terminal, cause the terminal to: send a test instruction to a smart device that causes the smart device to perform a network connection test according to the test instruction; receive a result of the network connection test from the smart device; and display the result of the network connection test.

It shall be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 is a flowchart showing a method for testing a smart device, according to an exemplary embodiment.

FIG. 2 is a flowchart showing a method for testing a smart device, according to an exemplary embodiment.

FIG. 3 is a flowchart showing a method for testing a smart device, according to an exemplary embodiment.

FIG. 4 is a diagram illustrating a home application scenario, according to an exemplary embodiment.

FIG. 5 is a block diagram showing an apparatus for testing a smart device, according to an exemplary embodiment.

FIG. 6 is a block diagram showing an apparatus for testing a smart device, according to an exemplary embodiment.

FIG. 7 is a block diagram showing a first connection unit, according to an exemplary embodiment.

FIG. 8 is a block diagram showing an apparatus for testing a smart device, according to an exemplary embodiment.

FIG. 9 is a block diagram showing an apparatus for testing a smart device, according to an exemplary embodiment.

FIG. 10 is a block diagram showing a second connection unit, according to an exemplary embodiment.

FIG. 11 is a block diagram showing a structure of an apparatus for testing a smart device, according to an exemplary embodiment.

### DETAILED DESCRIPTION

Reference will now be made in detail to exemplary embodiments, examples of which are illustrated in the accompanying drawings. The following description refers to the accompanying drawings in which the same or similar numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims.

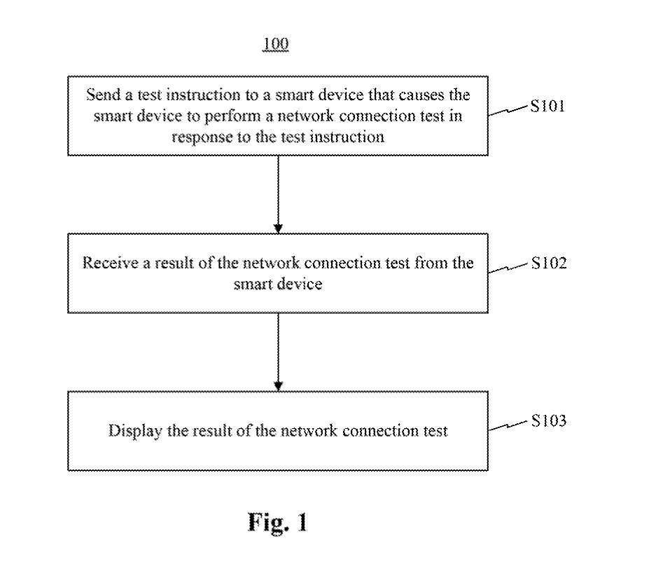

FIG. 1 is a flowchart showing a method 100 for testing a smart device, according to an exemplary embodiment. Referring to FIG. 1, the method 100 for testing a smart device may be used in a terminal and includes the following steps.

In step S101, a test instruction is sent to a smart device to cause the smart device to perform a network connection test in response to the test instruction.

In an embodiment, the terminal may first establish a point-to-point connection with the smart device, and send the test instruction to the smart device through the point-to-point connection according to a designated operation by a user. After receiving the test instruction, the smart device may perform a network connection test.

In step S102, a result of the network connection test returned by the smart device is received.

In the embodiment, the smart device may return the result of the network connection test to the terminal. The result of the network connection test includes information regarding a successful connection or information regarding a failed connection. The information regarding the failed connection includes a reason for the connection failure.

In step S103, the result of the network connection test is displayed. Based on the result of the network connection test received in step S102, the terminal displays the result of the network connection test for the user.

It can be seen from the above description that the smart device of the present disclosure may perform a network connection test after receiving a test instruction sent from a terminal and return a result of the network connection test to the terminal, which allows the terminal to display the result of the network connection test to a user so that the user may determine the network connectivity status of the smart device. Consequently user experience is improved.

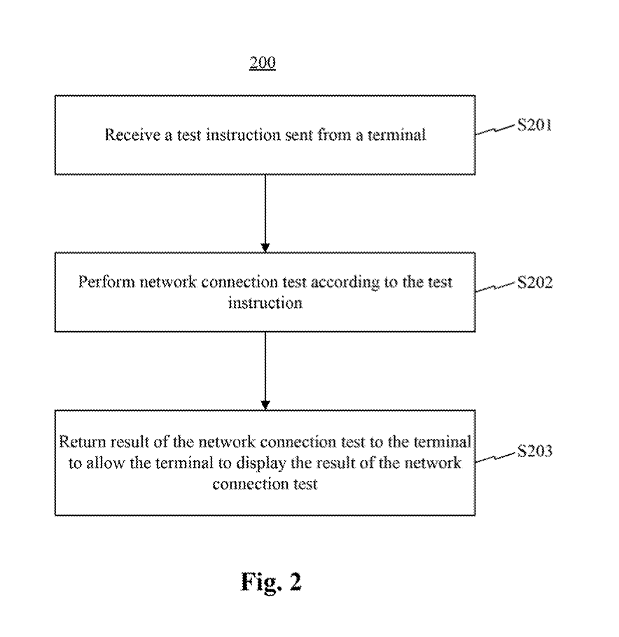

FIG. 2 is a flowchart showing a method 200 for testing a smart device, according to an exemplary embodiment. Referring to FIG. 2, the method 200 for testing a smart device may be used in a smart device, and include the following steps.

In step S201, a test instruction sent from a terminal is received.

In the embodiment, the smart device may first establish a point-to-point connection with the terminal and subsequently receive the test instruction sent by the terminal through the point-to-point connection.

In step S202, a network connection test is performed according to the test instruction.

In step S203, a result of the network connection test is returned to the terminal to allow the terminal to display the result of the network connection test.

In the embodiment, if the smart device successfully accesses the Internet, the smart device returns the result of the network connection test, which indicates the successful connection, to the terminal. If the smart device fails to access the Internet, the smart device returns the result of the network connection test, which indicates the connection failure, to the terminal. Further, the smart device may concurrently return to the terminal a reason for why the smart device fails to access the Internet.

It can be seen from the above description that the smart device of the present disclosure may perform a network connection test after receiving a test instruction sent from a terminal, and return a result of the network connection test to the terminal allowing the terminal to display the result of the network connection test to a user, so that the user may determine the network connectivity status of the smart device. Consequently, user experience is improved.

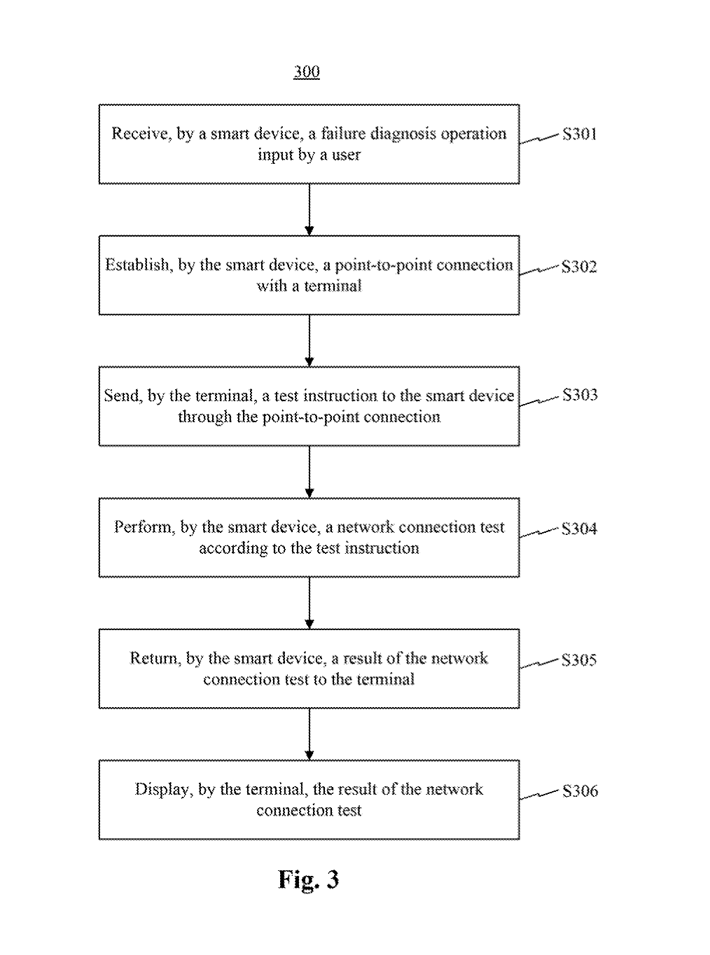

FIG. 3 is a flowchart showing another method 300 for testing a smart device, according to an exemplary embodiment. Referring to FIG. 3, the method 300 for testing a smart device may include the following steps.

In step S301, a smart device receives a failure diagnosis operation input by a user.

In the present embodiment, when a user wants to test the network connectivity status of a smart device, the user may input a failure diagnosis operation on the smart device. For example, the user may input the failure diagnosis operation through a designated key on the smart device or may input the failure diagnosis operation with a preset key combination such as two consecutive long pressing on a designated key. The present disclosure does not impose specific limitations on the user input.

In step S302, the smart device establishes a point-to-point connection with a terminal.

Based on the previous step S301, after receiving the failure diagnosis operation input by the user, the smart device may perform the following two operations depending on its network connection status: (1) when the smart device is connected to the Internet, the smart device disconnects from the Internet and establishes a point-to-point connection with the terminal; and (2) when the smart device is not connected to the Internet, the smart device immediately establishes a point-to-point connection with the terminal

The smart device may establish the point-to-point connection with the terminal through a wired transmission, a Wireless Fidelity (WiFi) transmission, or a Bluetooth transmission. For example, the user may connect the terminal to the smart device with a cable and the smart device may establish a wired point-to-point connection with the terminal after receiving the failure diagnosis operation input by the user. As another example, the smart device may initiate a Bluetooth function after receiving the failure diagnosis operation input by the user, and then establish, through Bluetooth, a point-to-point connection with a terminal which has initiated its own Bluetooth function. One of ordinary skill in this art may employ other transmission types to establish the point-to-point connection between the smart device and the terminal according to related technologies, and the present disclosure does not impose specific limitations on the type of transmission used.

In step S303, the terminal sends a test instruction to the smart device through the point-to-point connection.

After the smart device establishes a point-to-point connection with the terminal, the user may send a test instruction to the smart device through the terminal. For example, the user may send the test instruction to the smart device through an application (APP) capable of controlling the smart device that is installed on the terminal.

In an exemplary embodiment of the present disclosure, when the smart device establishes the point-to-point connection with the terminal, the terminal may display an indication showing that the point-to-point connection with the smart device has been established. In response to a prompt, the user may input an instruction on the terminal to send a test instruction. For example, by tapping on a preset button, by voice input, or the like, the user may input an instruction for sending the test instruction. After receiving the instruction for sending the test instruction, the terminal sends the test instruction to the smart device through the point-to-point connection.

In step S304, the smart device performs a network connection test according to the test instruction.

As a result of step S302, the smart device is not connected to the Internet. Thus in step S304, the smart device performs a network connection test according to the test instruction after receiving the test instruction from the terminal.

In step S305, the smart device returns a result of the network connection test to the terminal.

In the present embodiment, after the smart device completes the network connection test, the smart device returns a result of the network connection test to the terminal. The result of the network connection test may include information regarding a successful connection or information regarding a failed connection. If the smart device successfully accesses the Internet, the smart device returns the result of the network connection test, which indicates the successful connection, to the terminal. If the smart device fails to access the Internet, the smart device returns the result of the network connection test, which indicates the failed connection, to the terminal. The smart device may try to access the Internet again when the smart device fails to initially access the Internet. When a preset number of connection attempts has been reached and the smart device still fails to access the Internet, the smart device returns the result of the network connection test, which indicates the failed connection(s), to the terminal. Meanwhile, the smart device may also return to the terminal a reason for why the smart device fails to access the Internet. The reason why the smart device fails to access the Internet may include, for example, failure to obtain an IP address, failure to connect to a router, DNS (Domain Name System) parse failure, failed connection to the Internet server, or the like.

In step S306, the terminal displays the result of the network connection test.

After receiving the result of network connection test returned by the smart device (step S305), the terminal displays the result of the network connection test. If the result of the network connection test is the information regarding a failed connection, the user may perform an appropriate process based on to the result of the network connection test. For example, if the reason for why the smart device fails to access the Internet is a failed connection to a router, the user may try to reconfigure a white list of routers. As another example, if the reason for why the smart device fails to access the Internet is a failure to obtain an IP address, the user may try to restart the router in order to restart a DHCP (Dynamic Host Configuration Protocol) service. The present disclosure contemplates other appropriate processes.

In the embodiment, when the smart device fails to access the Internet, the smart device may return to the terminal a reason for why the smart device fails to access the Internet thus allowing user to perform a corresponding process with respect to the reason. Thereby, user experience is improved.

It can be seen from the above description that the smart device in the present disclosure may perform the network connection test after receiving the test instruction sent from the terminal and return a result of the network connection test to the terminal. The terminal may then display the result of the network connection test to the user so that the user may determine the network connectivity status of the smart device. Consequently, user experience is improved.

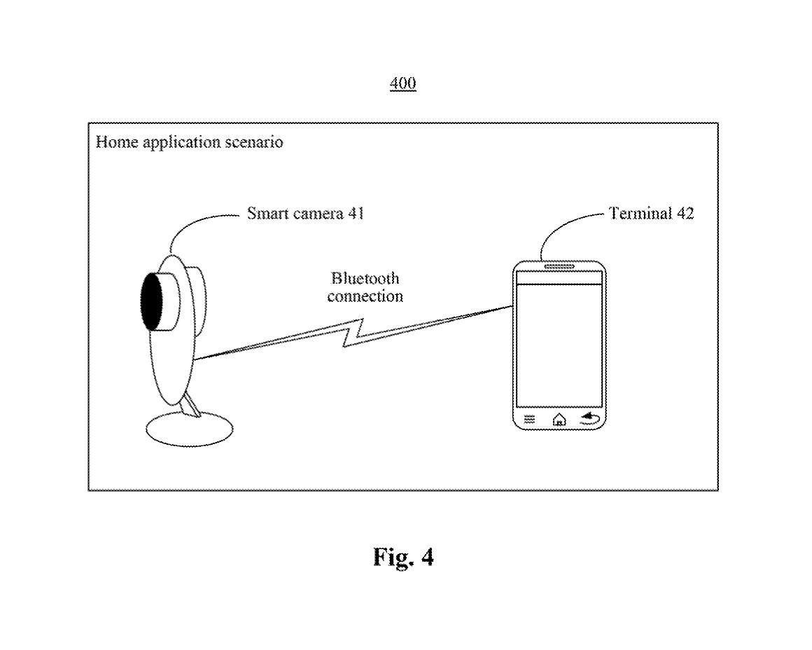

FIG. 4 is a diagram showing a home application scenario 400 based on the above described methods, according to an exemplary embodiment of the present disclosure. When a user wants to test the network connectivity status of a smart camera 41, the user may long press a testing key on the smart camera 41 to cause the smart camera 41 to disconnect from its current network connection. Subsequently, the smart camera initiates a Bluetooth function to establish a Bluetooth connection with a terminal 42. The user may send a test instruction to the smart camera 41 through the terminal 42. As a result, the smart camera 41 performs a network connection test and returns a result of the network connection test to the terminal 42 allowing the terminal 42 to display the result of the network connection test for the user's review.

In the application scenario 400 shown in FIG. 4, the terminal 42 may test the smart camera 41 by the methods provided by the embodiments shown in FIG. 1 or 3 and the smart camera 41 may determine its network connectivity status by the method provided by embodiments shown in FIG. 2 or 3. Thus, a detailed description is not repeated here.

Corresponding to the above embodiments, which disclose methods for testing a smart device, the present disclosure further provides embodiments of an apparatus for testing a smart device.

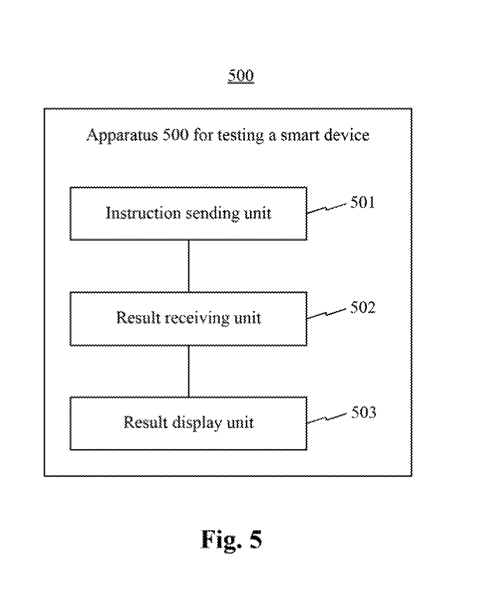

FIG. 5 is a block diagram showing an apparatus 500 for testing a smart device, according to an exemplary embodiment. Referring to FIG. 5, the apparatus 500 for testing a smart device may be included in a terminal and may include an instruction sending unit 501, a result receiving unit 502, and a result display unit 503.

The instruction sending unit 501 is configured to send a test instruction to a smart device to cause the smart device to perform a network connection test according to the test instruction.

The result receiving unit 502 is configured to receive a result of the network connection test returned by the smart device.

The result display unit 503 is configured to display the result of the network connection test.

In the above embodiment, the smart device may perform a network connection test after receiving a test instruction sent from a terminal and return a result of the network connection test to the terminal thus allowing the terminal to display the result of the network connection test, so that the user may determine the network connectivity status of the smart device. Consequently, user experience is improved.

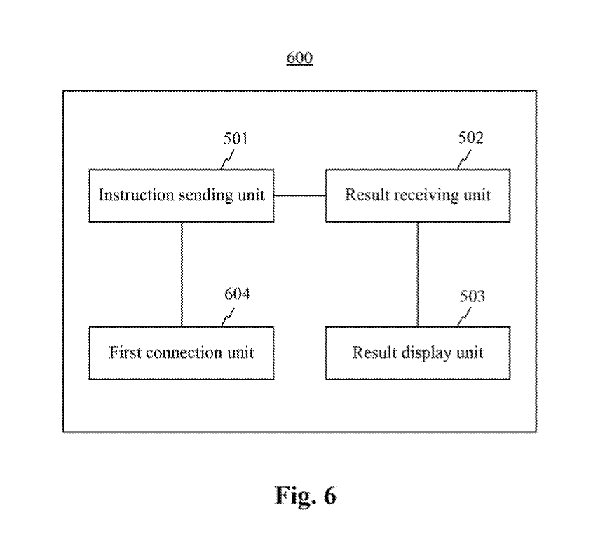

FIG. 6 is a block diagram showing another apparatus 600 for testing a smart device, according to an exemplary embodiment. Referring to FIG. 6, the apparatus 600 for testing a smart device may further include a first connection unit 604, in addition to the instruction sending unit 501, the result receiving unit 502, and the result display unit 503 (FIG. 5).

The first connection unit 604 is configured to, before the test instruction is sent to the smart device, establish a point-to-point connection with the smart device.

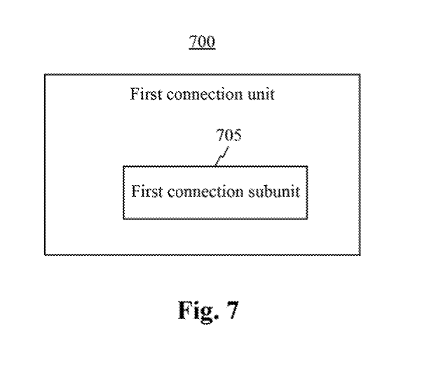

FIG. 7 is a block diagram showing a first connection unit 700, according to an exemplary embodiment. For example, the first connection unit 700 may be the first connection unit 604 (FIG. 6).

Referring to FIG. 7, the first connection unit 700 may include a first connection subunit 705. The first connection subunit 705 is configured to establish the point-to-point connection with the smart device through a wired transmission, a WiFi transmission, or a Bluetooth transmission.

Optionally, the result of the network connection test includes information regarding a successful connection or information regarding a failed connection.

The information regarding a failed connection includes a reason for the connection failure.

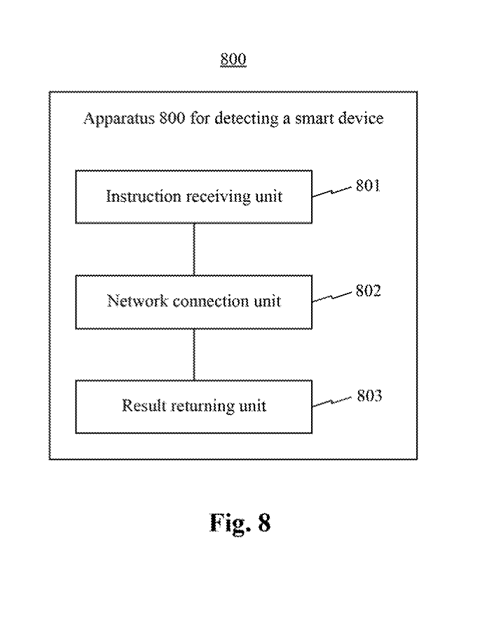

FIG. 8 is a block diagram showing an apparatus 800 for testing a smart device, according to an exemplary embodiment. Referring to FIG. 8, the apparatus 800 for testing a smart device may be used in a smart device and may include an instruction receiving unit 801, a network connection unit 802, and a result returning unit 803.

The instruction receiving unit 801 is configured to receive a test instruction sent from a terminal.

The network connection unit 802 is configured to perform a network connection test according to the test instruction.

The result returning unit 803 is configured to return a result of the network connection test to the terminal to allow the terminal to display the result of the network connection test.

In the above embodiment, the smart device may perform the network connection test after receiving the test instruction sent from the terminal and return the result of the network connection test to the terminal thus allowing the terminal to display the result of the network connection test to a user, so that the user may determine the network connectivity status of the smart device. Consequently, user experience is improved.

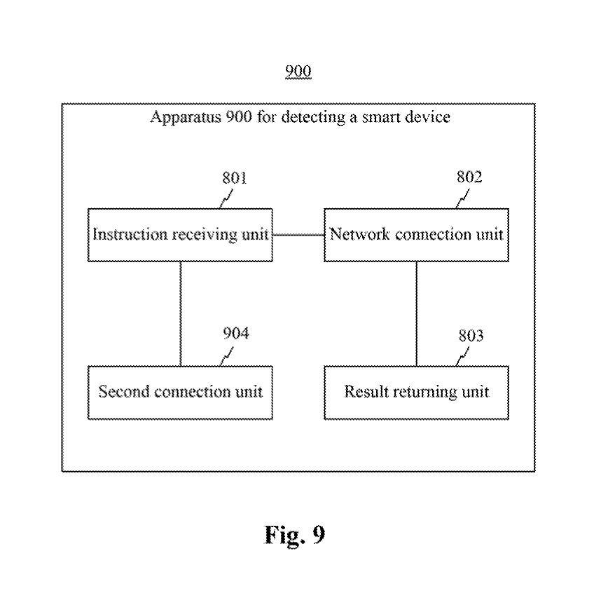

FIG. 9 is a block diagram showing another apparatus 900 for testing a smart device, according to an exemplary embodiment. Referring to FIG. 9, the apparatus 900 for testing a smart device may further include a second connection unit 904, in addition to the instruction receiving unit 801, the network connection unit 802, and the result returning unit 803 (FIG. 8).

The second connection unit 904 is configured to, before the test instruction sent from the terminal is received, establish a point-to-point connection with the terminal

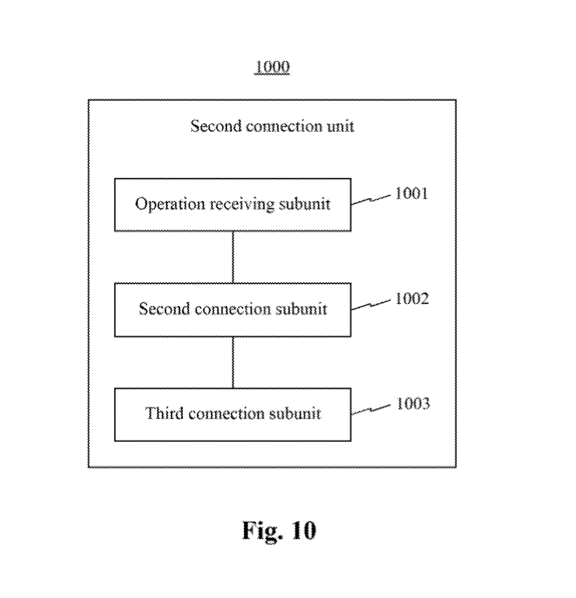

FIG. 10 is a block diagram showing a second connection unit 1000, according to an exemplary embodiment. For example, the second connection unit 1000 may be the second connection unit 904 (FIG. 8).

Referring to FIG. 10, the second connection unit 1000 may include an operation receiving subunit 1001, a second connection subunit 1002, and a third connection subunit 1003.

The operation receiving subunit 1001 is configured to receive a failure diagnosis operation input by a user.

The second connection subunit 1002 is configured to, when the smart device is connected to the Internet, disconnect from the Internet and establish a point-to-point connection with the terminal.

The third connection subunit 1003 is configured to, when the smart device is not connected to the Internet, establish a point-to-point connection with the terminal.

Optionally, the result of the network connection test includes information regarding a successful connection or information regarding a failed connection.

The information regarding a failed connection includes a reason for connection failure.

For realizing of functions of the respective units in the above apparatus, refer to the above description regarding corresponding steps in the methods. A detailed description is not repeated here.

The above described embodiments are only illustrative, and portions described as separate units may or may not be physically separated. Additionally, the portions shown as respective units may or may not be physical units (e.g., the portions may be located in one place or may be distributed over a plurality of units). A part or whole of the modules may be selected to realize the objects of the present disclosure depending on practical requirements.

One of ordinary skill in the art will understand that the above-described units can each be implemented by hardware, or software, or a combination of hardware and software. One of ordinary skill in the art will also understand that multiple ones of the above-described units may be combined as one unit, and each of the above-described units may be further divided into a plurality of sub-units.

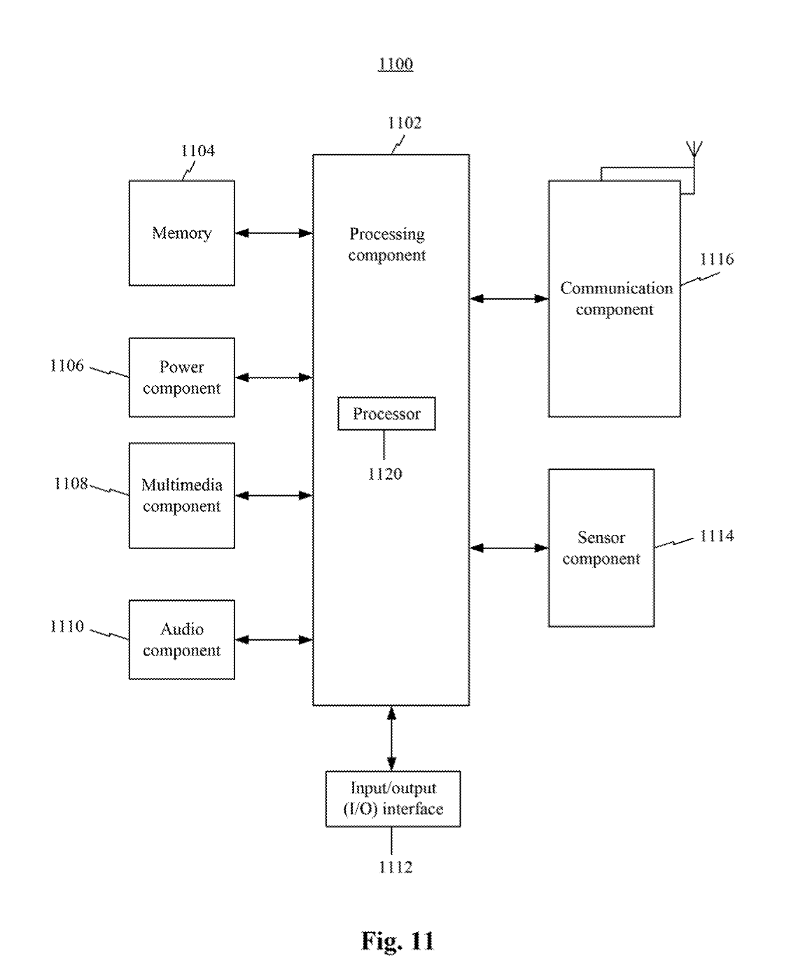

FIG. 11 is a block diagram of an apparatus 1100 for testing a smart device, according to an exemplary embodiment. For example, the apparatus 1100 may be a mobile phone, a computer, a digital broadcast terminal, a messaging device, a gaming console, a tablet, a medical device, exercise equipment, a personal digital assistant, or the like.

Referring to FIG. 11, the apparatus 1100 may include one or more of the following components: a processing component 1102, a memory 1104, a power component 1106, a multimedia component 1108, an audio component 1110, an input/output (I/O) interface 1112, a sensor component 1114, and a communication component 1116.

The processing component 1102 typically controls overall operations of the apparatus 1100, such as the operations associated with display, telephone calls, data communications, camera operations, and recording operations. The processing component 1102 may include one or more processors 1120 to execute instructions to perform all or part of the steps in the above described methods. Moreover, the processing component 1102 may include one or more modules which facilitate the interaction between the processing component 1102 and other components. For instance, the processing component 1102 may include a multimedia module to facilitate the interaction between the multimedia component 1108 and the processing component 1102.

The memory 1104 is configured to store various types of data to support the operation of the apparatus 1100. Examples of such data include instructions for any applications or methods operated on the apparatus 1100, contact data, phonebook data, messages, pictures, video, etc. The memory 1104 may be implemented using any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 1106 provides power to various components of the apparatus 1100. The power component 1106 may include a power management system, one or more power sources, and any other components associated with the generation, management, and distribution of power in the apparatus 1100.

The multimedia component 1108 includes a screen providing an output interface between the apparatus 1100 and the user. In some embodiments, the screen may include a liquid crystal display (LCD) and a touch panel (TP). If the screen includes the touch panel, the screen may be implemented as a touch screen to receive input signals from the user. The touch panel includes one or more touch sensors to sense touches, swipes, and gestures on the touch panel. The touch sensors may not only sense a boundary of a touch or swipe action, but also sense a period of time and a pressure associated with the touch or swipe action. In some embodiments, the multimedia component 1108 includes a front camera and/or a rear camera. The front camera and the rear camera may receive an external multimedia datum while the apparatus 1100 is in an operation mode, such as a photographing mode or a video mode. Each of the front camera and the rear camera may be a fixed optical lens system or have focus and optical zoom capability.

The audio component 1110 is configured to output and/or input audio signals. For example, the audio component 1110 includes a microphone configured to receive an external audio signal when the apparatus 1100 is in an operation mode, such as a call mode, a recording mode, and a voice recognition mode. The received audio signal may be further stored in the memory 1104 or transmitted via the communication component 1116. In some embodiments, the audio component 1110 further includes a speaker to output audio signals.

The I/O interface 1112 provides an interface between the processing component 1102 and peripheral interface modules, such as a keyboard, a click wheel, buttons, and the like. The buttons may include, but are not limited to, a home button, a volume button, a starting button, and a locking button.

The sensor component 1114 includes one or more sensors to provide status assessments of various aspects of the apparatus 1100. For instance, the sensor component 1114 may detect an open/closed status of the apparatus 1100, relative positioning of components, e.g., the display and the keypad, of the apparatus 1100, a change in position of the apparatus 1100 or a component of the apparatus 1100, a presence or absence of user contact with the apparatus 1100, an orientation or an acceleration/deceleration of the apparatus 1100, and a change in temperature of the apparatus 1100. The sensor component 1114 may include a proximity sensor configured to detect the presence of nearby objects without any physical contact. The sensor component 1114 may also include a light sensor, such as a CMOS or CCD image sensor, for use in imaging applications. In some embodiments, the sensor component 1114 may also include an accelerometer sensor, a gyroscope sensor, a magnetic sensor, a pressure sensor, or a temperature sensor.

The communication component 1116 is configured to facilitate communication, wired or wirelessly, between the apparatus 1100 and other devices. The apparatus 1100 can access a wireless network based on a communication standard, such as WiFi, 2G, or 3G, or a combination thereof. In one exemplary embodiment, the communication component 1116 receives a broadcast signal or broadcast associated information from an external broadcast management system via a broadcast channel In one exemplary embodiment, the communication component 1116 further includes a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, and other technologies.

In exemplary embodiments, the apparatus 1100 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above described methods.

In exemplary embodiments, there is also provided a non-transitory computer-readable storage medium including instructions, such as included in the memory 1104, executable by the processor 1120 in the apparatus 1100, for performing the above-described methods. For example, the non-transitory computer-readable storage medium may be a ROM, a RAM, a CD-ROM, a magnetic tape, a floppy disc, an optical data storage device, and the like.

Other embodiments of the present disclosure will be apparent to those skilled in the art from consideration of the specification and practice of the invention disclosed here. This application is intended to cover any variations, uses, or adaptations of the present disclosure following the general principles thereof and including such departures from the present disclosure as come within known or customary practice in the art. It is intended that the specification and examples be considered as exemplary only, with a true scope and spirit of the invention being indicated by the following claims.

It will be appreciated that the present disclosure is not limited to the exact construction that has been described above and illustrated in the accompanying drawings, and that various modifications and changes can be made without departing from the scope thereof. It is intended that the scope of the invention only be limited by the appended claims.

What is claimed is:

1. A method for testing a smart device with a terminal, comprising:
sending a test instruction to a smart device that causes the smart device to perform a network connection test according to the test instruction;
receiving a result of the network connection test from the smart device; and
displaying the result of the network connection test.

2. The method of claim 1, before sending the test instruction to the smart device, further comprising:
establishing a point-to-point connection with the smart device.

3. The method of claim 2, wherein the establishing comprises:
establishing the point-to-point connection with the smart device through one of a wired transmission, a WiFi transmission, or a Bluetooth transmission.

4. The method of claim 1, wherein:
the result of the network connection test comprises information regarding a successful connection or information regarding a failed connection, wherein the information regarding the failed connection includes a reason for the failed connection.

5. An apparatus for testing a smart device, comprising:
a processor; and
a memory for storing instructions executable by the processor;
wherein the processor is configured to:
send a test instruction to a smart device that causes the smart device to perform a network connection test according to the test instruction;
receive a result of the network connection test from the smart device; and
display the result of the network connection test.

6. The apparatus of claim 5, wherein the processor is further configured to:
establish a point-to-point connection with the smart device before sending the test instruction to the smart device.

7. The apparatus of claim 6, wherein the processor is further configured to:
establish the point-to-point connection with the smart device through one of a wired transmission, a WiFi transmission, or a Bluetooth transmission.

8. The apparatus of claim 5, wherein the result of the network connection test comprises information regarding a successful connection or information regarding a failed connection, wherein the information regarding the failed connection includes a reason for the failed connection.

9. A non-transitory computer-readable storage medium having stored therein instructions that, when executed by one or more processors of a terminal, cause the terminal to:
send a test instruction to a smart device that causes the smart device to perform a network connection test according to the test instruction;
receive a result of the network connection test from the smart device; and
display the result of the network connection test.
